(19) United States
(12) Patent Application Publication
(10) Pub. No.: US 2025/0105571 A1
(43) Pub. Date: Mar. 27, 2025

(54) SLIP RING ASSEMBLY

(71) Applicant: Global Dynamics Inc., Calgary (CA)

(72) Inventor: Colin BROCK, Calgary (CA)

(73) Assignee: Global Dynamics Inc., Calgary (CA)

(21) Appl. No.: 18/894,509

(22) Filed: Sep. 24, 2024

(30) Foreign Application Priority Data
Sep. 25, 2023 (CA) 3 213 970

(51) Int. Cl. H01R 39/62

(52) U.S. Cl. CPC H01R 39/62

(57) ABSTRACT

A slip ring assembly has an inner ring having an inner ring peripheral wall, an outer wall having an outer ring peripheral wall, and a contact ring having at least one conductive surface positioned between the inner ring and the outer ring. The inner ring has a first inner ring portion and a second inner ring portion that are attachable to each other to create the inner ring. The outer ring has a first outer ring portion and a second outer ring portion that are attachable to each other to create the outer ring. The contact ring has a brush assembly with at least one brush. The contact ring has a first contact ring portion and a second contact ring portion that are attachable to each other to create the contact ring.

### FIELD OF THE DISCLOSURE

The present application relates generally to a slip ring assembly, and more particularly relates to a split slip ring assembly.

### BACKGROUND

This section provides background information to facilitate a better understanding of the various aspects of the invention. It should be understood that the statements in this section of this document are to be read in this light, and not as admissions of prior art.

Basic slip rings are installed at the end of a rotating shaft on a coiled tubing reel to provide a rotating electrical connection to conductors located inside the coiled tubing string. In some situations, it is not possible to use a basic slip ring. The current solution where a basic slip ring cannot be used is to lift the coiled tubing reel out of its framework and slide a basic slip ring over the end of the shaft before reinstalled the coiled tubing reel back into its framework. This process is time consuming and awkward to complete.

### BRIEF SUMMARY

There is provided a slip ring assembly that has an inner ring, an outer ring, and a contact ring. The inner ring has an inner ring peripheral wall and the outer ring has an outer ring peripheral wall. The outer ring is sized such that the outer ring encompasses the inner ring. The contact ring is positioned between the inner ring and the outer ring. A brush assembly is mounted to the outer ring peripheral wall. The brush assembly has brushes that contact the conductive surface of the contact ring. The inner ring comprises a first inner ring portion and a second inner ring portion. The first inner ring portion is attachable to the second inner ring portion to create the inner ring. The first inner ring portion and the second inner ring portion may be shaped as a semi-circle such that a completed ring is created when the first inner ring portion and the second inner ring portion are attached together. The outer ring comprises a first outer ring portion and a second outer ring portion. The first outer ring portion is attachable to the second outer ring portion to create the outer ring. The first outer ring portion and the second outer ring portion may be shaped as a semi-circle such that a completed ring is created when the first outer ring portion and the second outer ring portion are attached together. The contact ring comprises a first contact ring portion and a second contact ring portion. The first contact ring portion is attachable to the second contact ring portion to create the contact ring. The first contact ring portion and the second contact ring portion may be shaped as a semi-circle such that a completed ring is created when the first contact ring portion and the second contact ring portion are attached together.

In one embodiment, the contact ring has at least one bushing to prevent wear between the inner ring and the outer ring as the inner ring rotates and centralize the outer ring on the inner ring.

In one embodiment, an anti-rotation bracket is positioned on a side of the outer ring for holding the outer ring in a fixed position.

In one embodiment, a dust shield is attached to at least one of the outer ring and the inner ring such that the contact ring is shielded from dust particles. The dust shield may be made up of at least two dust shield portions.

In one embodiment, a first cord grip is positioned through the outer ring and in alignment with the brush assembly. A second cord grip is positioned through the inner ring.

In one embodiment, a secondary electrical port is provided for optional installation of a second brush assembly.

In one embodiment, at least one bushing is positioned between the inner ring and the outer ring.

In one embodiment, the at least one conductive surface of the contact ring comprises at least one conductive contact ring. At least one insulating ring is provided to create separation between each of the at least one conductive contact rings and the inner ring.

In one embodiment, the first outer ring portion is attached to the second outer ring portion by a hinged connection the first inner ring portion is attached to the second inner ring portion by a hinged connection.

In one embodiment, the bearing is a split rotatable bushing.

### BRIEF DESCRIPTION OF THE DRAWINGS

These and other features will become more apparent from the following description in which references are made to the following drawings, in which numerical references denote like parts. The drawings are for the purpose of illustration only and are not intended to in any way limit the scope of the invention to the particular embodiments shown.

FIG. 1 is a perspective view of a slip ring assembly.

FIG. 2 is a top elevation view of the slip ring assembly.

FIG. 3 is a side elevation view of the slip ring assembly.

FIG. 4 is a bottom elevation view of the slip ring assembly.

FIG. 5 is an exploded view of an inner ring and contact ring of the slip ring assembly.

FIG. 6 is an exploded view of the slip ring assembly.

FIG. 7 is an exploded view of the slip ring assembly with hinged connections.

### DETAILED DESCRIPTION OF THE PREFERRED EMBODIMENTS

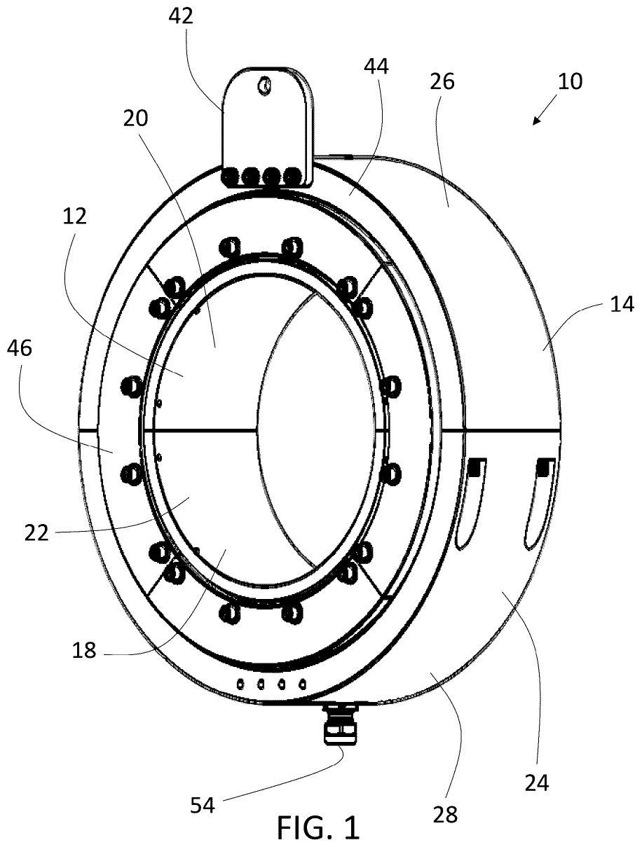

A slip ring assembly, generally identified by reference numeral 10, will now be described with reference to FIG. 1 through FIG. 7.

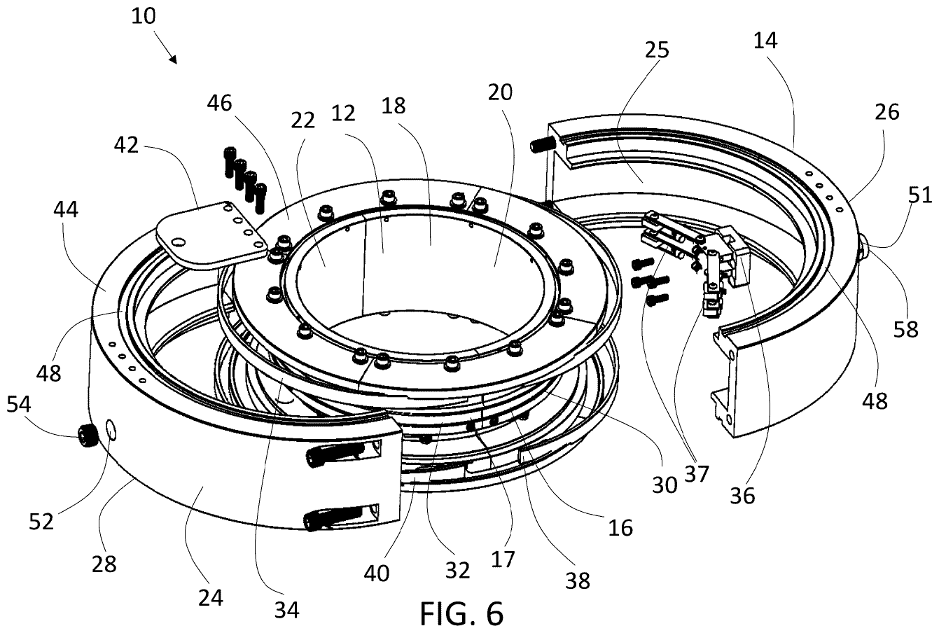

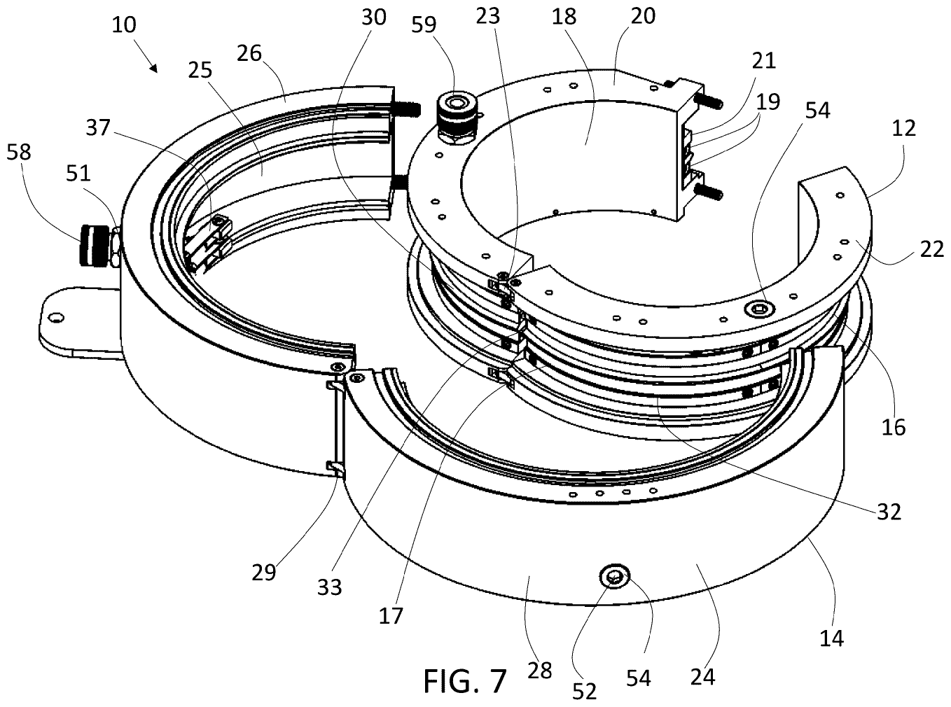

Referring to FIG. 6, a slip ring assembly 10 has an inner ring 12, an outer ring 14 sized to encompass the inner ring, and a contact ring 16 positioned between inner ring 12 and outer ring 14. Inner ring 12 rotates relative to outer ring 14. Inner ring 12 has an inner ring peripheral wall 18. Inner ring 12 and inner ring peripheral wall 18 are divided into at least two portions, a first inner ring portion 20 and a second inner ring portion 22. First inner ring portion 20 is attachable to second inner ring portion 22 to create inner ring 12. In the embodiment shown, first inner ring portion 20 and second inner ring portion 22 are each shaped as semi-circles and have a relatively consistent length. However, it will be understood by a person skilled in the art that first inner ring portion 20 and second inner ring portion 22 are not required to be similar in length. First inner ring portion 20 and second inner ring portion 22 may be attached by a hinged connection 23, shown in FIG. 7, at one end or may be attachable using screws, dowels, or any other suitable fastener known to a person skilled in the art. It will be understood by a person skilled in the art that inner ring 12 and inner ring peripheral wall 18 may be divided into more than two portions.

Outer ring 14 has an outer ring peripheral wall 24. Outer ring 14 and outer ring peripheral wall 24 are divided into at least two portions, a first outer ring portion 26 and a second outer ring portion 28. First outer ring portion 26 is attachable to second outer ring portion 28 to create outer ring 14. In the embodiment shown, first outer ring portion 26 and second outer ring portion 28 are each shaped as semi-circles and have a relatively consistent length. However, it will be understood by a person skilled in the art that first outer ring portion 26 and second outer ring portion 28 are not required to be similar in length. First outer ring portion 26 and second outer ring portion 28 may be attached by a hinged connection 29, shown in FIG. 7, at one end or may be attachable using screws, dowels, or any other suitable fastener known to a person skilled in the art. It will be understood by a person skilled in the art that outer ring 14 and outer ring peripheral wall 24 may be divided into more than two portions. It will further be understood that inner ring 12 may be divided into a different number of portions than outer wall 14.

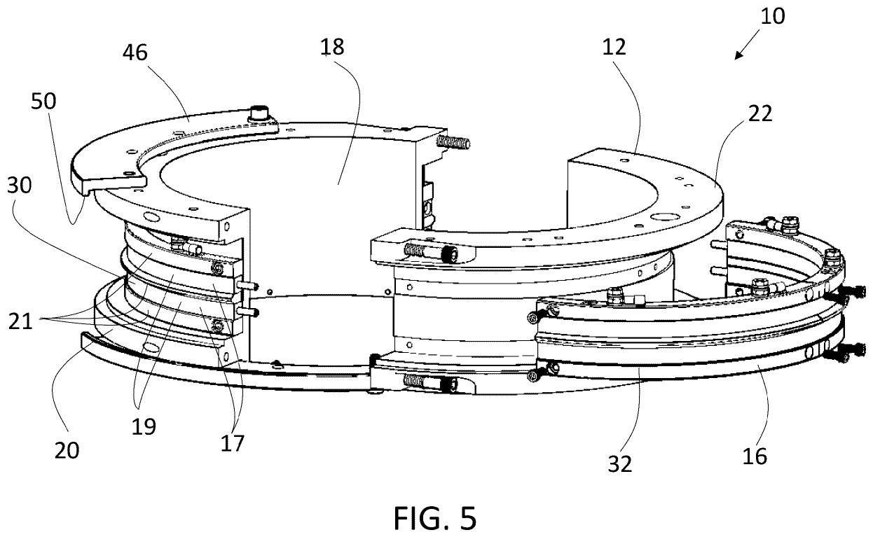

Referring to FIG. 5, contact ring 16 has at least one conductive surface 17. Contact ring 16 is divided into at least two portions, a first contact ring portion 30 and a second contact ring portion 32. First contact ring portion 30 is attachable to second contact ring portion 32 to create contact ring 16. In the embodiment shown, first contact ring portion 30 and second contact ring portion 32 are shaped as semi-circles and have a relatively consistent length. However, it will be understood by a person skilled in the art that first contact ring portion 30 and second contact ring portion 32 are not required to be similar in length. First contact ring portion 30 and second contact ring portion 32 may be attached any means known to a person skilled in the art including simple contact of the ends, screws, dowels, or any other suitable fastener known to a person skilled in the art. Referring to FIG. 6, a brush assembly 36 having at least one brush 37 is provided. Brush assembly 36 is attached to outer ring peripheral wall 24. In the embodiment shown, brush assembly 36 is mounted on an interior surface 25 of outer ring peripheral wall 24, however it will be understood by a person skilled in the art that other methods of attaching brush assembly 36 to outer ring peripheral wall 24 may be used. Brushes 37 contact conductive surfaces 17 of contact ring 16. Brush assembly 36 accepts an electrical current from an electrical connection, not shown, and transfers the electrical current to conductive surfaces 17. Brush assembly 36 acts to provide electrical connections between slip ring assembly 10 and coiled tubing portions, not shown.

Referring to FIG. 5, in the embodiment shown, conductive surfaces 17 of contact ring 16 are made up of conductive contact rings 19. Insulating rings 21 are provided to separate conductive contact rings 19 from each other and inner ring 14. In the embodiment shown, two conductive contact rings 19 are provided, however it will be understood by a person skilled in the art that additional conductive contact rings 19 may be included. In addition to separating conductive contact rings 19, insulating rings 21 provide a guide function. Brushes 37 of brush assembly 36 slide on contact ring 16 as inner ring 14 rotates and insulating rings 21 guide brushes 37 to maintain proper alignment with contact ring 16.

Referring to FIG. 6, contact ring 16 includes a bearing that encompasses contact ring 16 and is positioned between contact ring 16 and outer ring 14. In the embodiment shown, bearing is a bushing 34 and is more specifically a split bushing comprising a first bushing section 38 and a second bushing section 40 that accommodates separation when first contact ring portion 30 and second contact ring portion 32 are separated. Bushing 34 acts as a bearing surface to minimize wear between parts of slip ring assembly 10. Bushing 34 is installed between inner ring 12 and outer ring 14. It will be understood by a person skilled in the art that any suitable bearing or bushing may be used.

In the embodiment shown in FIG. 6, the connections between first inner ring portion 20 and second inner ring portion 22, first outer ring portion 26 and second outer ring portion 28, first contact ring portion 30 and second contact ring portion 32, and first bushing section 38 and second bushing section 40 line up. This is beneficial to allow all portions to move in conjunction with each other so that slip ring 10 can be opened and closed as a whole instead of by layer. This saves significant time as a user does not need to build slip ring 10 layer by layer starting with inner ring 12 and ending with outer ring 14.

Referring to FIG. 1, an anti-rotation bracket 42 is positioned on a side 44 of outer ring 12 and is used to hold outer ring 12 in a fixed position relative to coiled tubing which may be rotating. Inner ring 14 is fixed to a rotating shaft of the coiled tubing drum. Anti-rotation bracket 42 is attached to outer ring 12 using screws, bolts, or any other suitable fastener known to a person skilled in the art and is positioned such that anti-rotation bracket 42 extends beyond outer ring 12 to allow for attachment to an anchoring structure, not shown. A person of skill in the art will understand that the anchoring structure can be a stake, piece of equipment, or any other suitable structure that will act to prevent rotation of slip ring assembly 10 when anti-rotation bracket 42 is attached to outer ring 12 and anchoring structure.

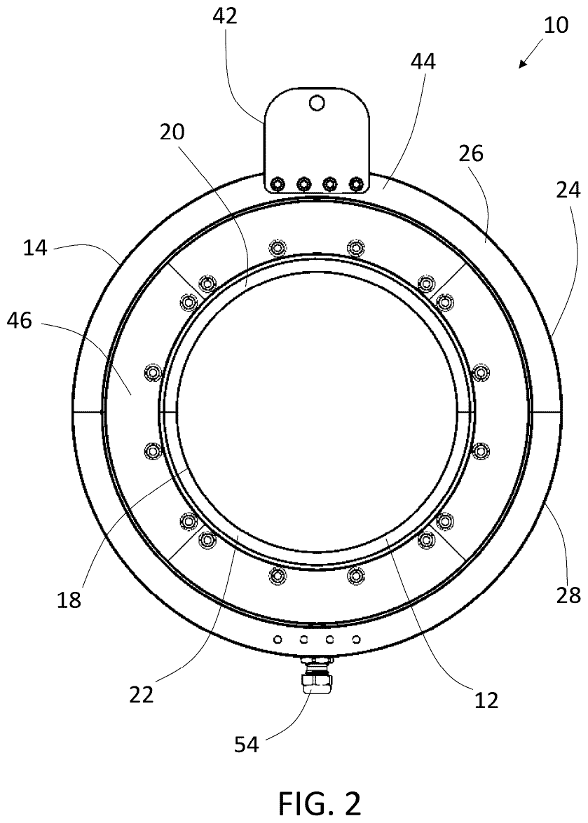

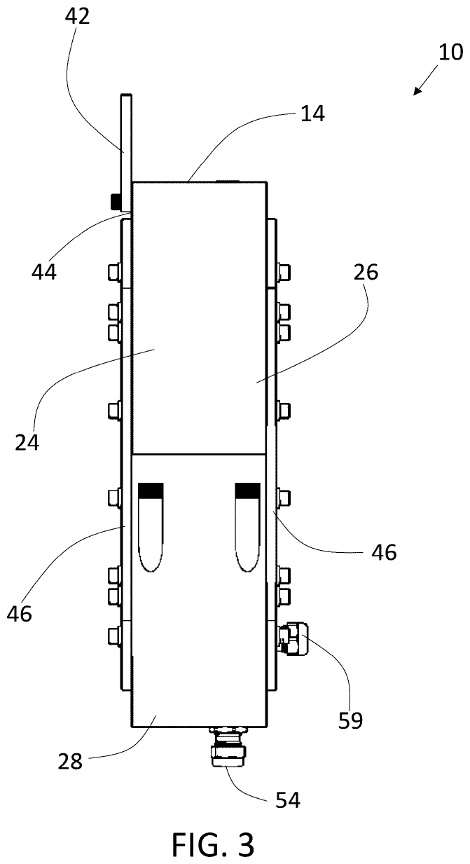

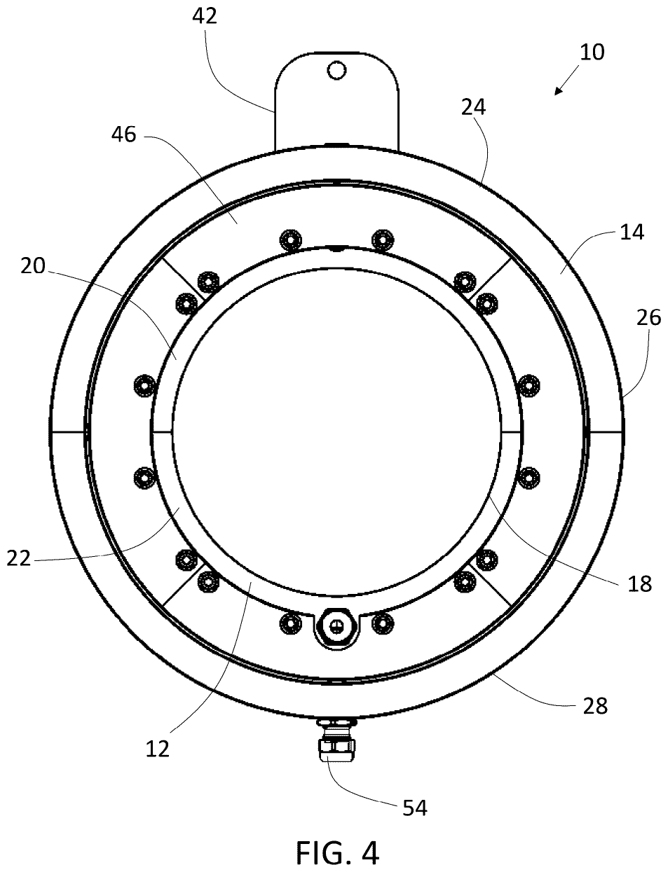

In the embodiment shown in FIG. 4, a dust shield 46 is provided to shield contact ring 16, bushing 34 and brush assembly 36 from dust and other environmental contaminants. Dust shield 46 may be bolted in place. In the embodiment shown in FIG. 2, dust shield 46 is bolted to inner ring 12. Referring to FIG. 6, outer ring 14 has a groove 48 in side 44 that corresponds to a lip 50, shown in FIG. 5, of dust shield 46. This helps to prevent dust shield 46 from slipping or interfering with contact ring 16 and helps to ensure proper placement of dust shield 46. Referring to FIG. 3, dust shield 46 may be positioned on both sides of slip ring 10. In the embodiments shown, dust shield 46 is made up of four dust shield portions. It will be understood by a person skilled in the art that dust shield 46 may be a single formed dust shield or may have two or more dust shield portions that make dust shield 46. Referring to FIG. 3, second cord grip 59 extends through dust shield 46.

Referring to FIG. 6, a first electrical port 51 is provided on peripheral wall 24 of outer ring 14 and provides for a connection between brush assembly 36 and coiled tubing connections, not shown. A secondary electrical port 52 with plug 54 may also be provided on peripheral wall 24 of outer ring 14. This can allow for a second brush assembly, not shown, to be installed if needed. Electrical ports 53 are also present on inner ring 12.

In the embodiment shown in FIG. 7, a first cord grip 58, shown in the present embodiment with a plug, is positioned through outer ring 14 to allow an electrical connection to be made to brush assembly 36. A second cord grip 59, shown in the present embodiment with a plug, is positioned through inner ring 12. First cord grip 58 and second cord grip help to prevent electrical connections from being twisted loose or pulled away from contact with brush assembly 36. First cord grip 58 and second cord grip 59 may also act as a seal and protect against damage from dirt, dust, debris, and other contaminants from entering slip ring 10, and may protect the electrical connection from stress and damage as it is run through outer ring 14 and inner ring 12.

Any use herein of any terms describing an interaction between elements is not meant to limit the interaction to direct interaction between the subject elements, and may also include indirect interaction between the elements such as through secondary or intermediary structure unless specifically stated otherwise.

In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be one and only one of the elements.

It will be apparent that changes may be made to the illustrative embodiments, while falling within the scope of the invention. As such, the scope of the following claims should not be limited by the preferred embodiments set forth in the examples and drawings described above, but should be given the broadest interpretation consistent with the description as a whole.

What is claimed is:

1. A slip ring assembly, comprising:
an outer ring having an outer ring peripheral wall, the outer ring being formed of a first outer ring portion and a second outer ring portion, the first outer ring portion being attachable to the second outer ring portion to create the outer ring;
an inner ring having an inner ring peripheral wall, the inner ring being sized such that the outer ring encompasses the inner ring, the inner ring being rotatable relative to the outer ring; the inner ring being formed of a first inner ring portion and a second inner ring portion, the first inner ring portion being attachable to the second inner ring portion to create the inner ring;
a contact ring having at least one conductive surface, the contact ring being positioned between the inner ring and the outer ring, the contact ring having a bearing, the contact ring being formed of a first contact ring portion and a second contact ring portion, the first contact ring portion being attachable to the second contact ring portion, the bearing being a split rotatable bearing to accommodate separation of the first contact ring portion and the second contact ring portion, the brush assembly being attached to the outer ring peripheral wall, the brush assembly having at least one brush, the at least one brush contacting the at least one conductive surface of the contact ring.

2. The slip ring assembly of claim 1 wherein the first inner ring portion and the second inner ring portion are each shaped as a semi-circle.

3. The slip ring assembly of claim 1 wherein the first outer ring portion and the second outer ring portion are each shaped as a semi-circle.

4. The slip ring assembly of claim 1 wherein the first contact ring portion and the second contact ring portion are each shaped as a semi-circle.

5. The slip ring assembly of claim 1 further comprising an anti-rotation bracket positioned on a side of the outer ring for holding the outer ring in a fixed position.

6. The slip ring assembly of claim 1 further comprising a dust shield attached to at least one of the outer ring and the inner ring such that the contact ring is shielded from dust particles.

7. The slip ring assembly of claim 6 wherein the dust shield comprises at least two dust shield portions.

8. The slip ring assembly of claim 1 wherein a first electrical connection is positioned through the outer ring and in alignment with the brush assembly and a second electrical connection is positioned through the inner ring.

9. The slip ring assembly of claim 8 wherein the first electrical connection is a first cord grip and the second electrical connection is a second cord grip.

10. The slip ring assembly of claim 1 further comprising a secondary electrical port for optional installation of a second brush assembly.

11. The slip ring assembly of claim 1 further comprising at least one bushing positioned between the inner ring and the outer ring.

12. The slip ring assembly of claim 1 where the at least one conductive surface of the contact ring comprises at least one conductive contact ring, at least one insulating ring is provided to create separation between each of the at least one conductive contact rings and the inner ring.

13. The slip ring assembly of claim 1 wherein the first outer ring portion being attachable to the second outer ring portion by a hinged connection, and the first inner ring portion being attachable to the second inner ring portion by a hinged connection.

14. The slip ring assembly of claim 1 wherein the bearing is a split rotatable bushing.
